(19) United States
(12) Patent Application Publication
(10) Pub. No.: US 2001/0035716 A1
(43) Pub. Date: Nov. 1, 2001

(54) Electroluminescent multiple segment display device

(76) Inventor: Matthew Murasko, Manhattan Beach, CA (US)

Correspondence Address: LATHROP & GAGE, LC, Suite 2800, 2345 Grand Boulevard, Kansas City, MO, 64108, US

(21) Appl. No.: 09/815,078

(22) Filed: Mar. 22, 2001

Related U.S. Application Data
(63) Continuation-in-part of application No. 09/548,560, filed on Apr. 13, 2000.

(51) Int. Cl. H05B 33/02; B05D 5/12

(52) U.S. Cl. 313/510; 313/509; 427/66

(57) ABSTRACT

A multiple-segment electroluminescent (EL) display device is fabricated by applying a rear electrode to a front surface of a substrate, applying at least one dielectric layer over the rear electrode, applying a phosphor layer over the dielectric layer to define a desired area of illumination, applying a layer of indium tin oxide ink over the phosphor layer, applying an outlining electrode layer, and applying a protective coating to the underlying layers. In one embodiment, a display panel is fabricated to include one or more EL multi-segment display devices. Each multi-segment display device in the panel includes a plurality of electroluminescent segments formed integrally therewith. A sign, scoreboard, or the like, may be readily constructed from an array of the present multisegment EL display devices suitably juxtaposed.

### RELATED APPLICATIONS

The following application is a continuation-in-part of patent application Ser. No. 09/548,560, which is a continuation-in-part of U.S. Pat. No. 6,203,391.

### FIELD OF THE INVENTION

This invention relates generally to electroluminescent display devices and, more particularly, to display panels including one or more such display devices comprising seven-segment display devices.

### BACKGROUND OF THE INVENTION

An electroluminescent (EL) display device generally includes a layer of phosphor positioned between two electrodes, and at least one of the electrodes is light-transmissive. At least one dielectric also is positioned between the electrodes so the EL display device functions essentially as a capacitor. When a voltage is applied across the electrodes, the phosphor material is activated and emits a light.

### Multiple Segment Displays

It is known in the art to fabricate alphabetic and numeric displays from a group of seven LED or LCD segments arranged in a pattern that is capable of displaying letters or numbers. Each segment in these multiple segment display devices (hereinafter ‘multi-segment displays’) may be selectively illuminated by a controller or driver to produce a display of the desired character, as is well known in the art.

### Problem

There are a number of drawbacks to utilizing neon lights or incandescent light bulbs to form an illuminated display sign. One disadvantage is that these types of devices are susceptible to breakage, not only in the shipping and sign manufacturing process, but particularly after being installed outdoors. Furthermore, it is a tedious procedure to construct signs such as scoreboards from a number of individual light bulbs. These bulbs must also be replaced periodically, which is a labor-consuming and awkward process, as scoreboards are often in a location difficult to access. Furthermore, incandescent bulbs produce a relatively large amount of heat, and neon lights require a bulky high-voltage supply. What is needed is a source of illumination that is durable, uses low voltage, produces little heat, and has a low profile and a long life expectancy.

### Solution

In accordance with the present invention, a display such as a sign is fabricated to include one or more multi-segment display devices. Each multi-segment display device includes a plurality of electroluminescent segments formed integrally therewith.

A sign, scoreboard, or the like, may be readily constructed from an array of the present multi-segment EL display devices suitably juxtaposed. In such a configuration, a controller selectively applies power to each individual EL device within the array, and a programmable microprocessor within controller provides the intelligence to determine which individual segments within a given device are driven to display the intended message. The desired alphabetic or numeric (‘alphanumeric’) characters are displayed via the microprocessor to change the sequence of display for various applications, including pricing charts, scoreboards, road signs such as speed limit signs and directional road signs that can be re-programmed (e.g., as a function of changing traffic patterns), and city bus information bars.

Other benefits of the present invention include extremely long operational life, very low heat emission, and low physical profile. In addition, the multi-segment display devices disclosed herein are very durable. For example, if a sign or other display panel fabricated in accordance with the present technology were dropped from a considerable distance, it would still light (i.e., not break), in contrast to neon lights, LEDs or incandescent light bulbs, all of which are fragile in comparison.

The electroluminescent multi-segment display device may be fabricated by performing the steps of applying a rear electrode to a front surface of a substrate, applying at least one dielectric layer over the rear electrode, applying a phosphor layer over the dielectric layer to define a desired area of illumination, applying a layer of indium tin oxide ink over the phosphor layer, applying an outlining electrode layer, and applying a protective coating to the underlying layers. The present method also facilitates applying the above-described layers to a translucent substrate in reverse order.

In one embodiment of the present invention, the illumination layer of the multi-segment EL display device are formed using organic materials (for example, light emitting polymers or OLEDs [organic light emitting devices]) that operate using low voltage. Signs or other panels incorporating these devices may be powered by a solar panel that stores solar energy in a storage device, such as a storage capacitor or battery, then delivers a specified low voltage to the panel.

### BRIEF DESCRIPTION OF THE DRAWINGS

FIG. 1 is a schematic illustration of an electroluminescent multi-segment display device in accordance with one embodiment of the present invention;

FIG. 2 is a flow chart showing an exemplary sequence of steps for fabricating the electroluminescent display device shown in FIG. 1;

FIG. 3 is a diagram further illustrating the sequence of steps shown in FIG. 2;

FIG. 4 is a schematic illustration of a rear electrode layer of a seven-segment EL display device in accordance with the embodiment of FIGS. 1 and 2;

FIG. 5 is a schematic illustration of dielectric, phosphor, conductive, and front electrode layers of the EL display device of FIGS. 1 and 2;

FIG. 6 is a schematic illustration of an electroluminescent multi-segment display device in accordance with an alternative embodiment of the present invention; and

FIG. 7 is a flow chart showing an exemplary sequence of steps for fabricating the electroluminescent display device shown in FIG. 6.

### DETAILED DESCRIPTION OF THE INVENTION

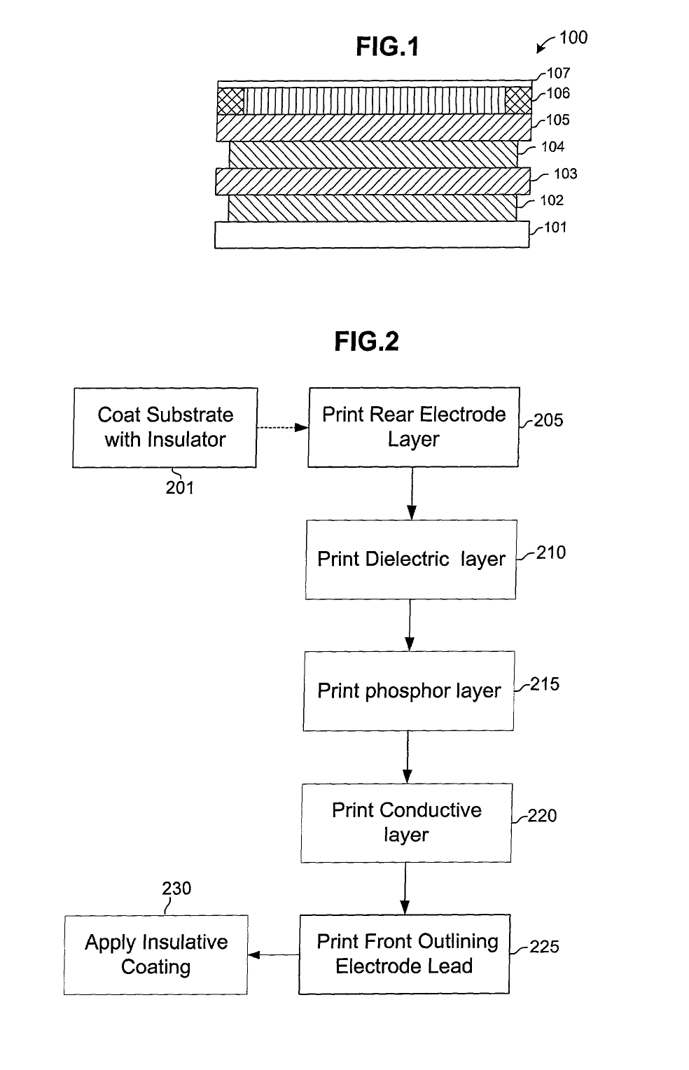

FIG. 1 is a schematic illustration of an electroluminescent (EL) multi-segment display device 100 comprising a substrate 101, a rear electrode layer 102, a dielectric layer 103, a phosphor layer 104, an electrically conductive layer 105, and a front outlining electrode lead (‘front electrode’) 106. Substrate 101 may comprise either metal or an electrically non-conducting material. If, for example, an aluminum substrate is used, then it is first coated with an insulative material.

Rear electrode 102 is formed of an electrically conductive material, e.g., silver or carbon particles. Dielectric layer 103 is formed of high dielectric constant material, such as barium titanate. Phosphor layer 104 is formed of electroluminescent phosphor particles, such as zinc sulfide doped with copper or manganese. Front electrode 106 may be formed of silver particles or other electrically conductive material. The entire sheet thus formed may be covered with a clear coating or colored translucent coating 107.

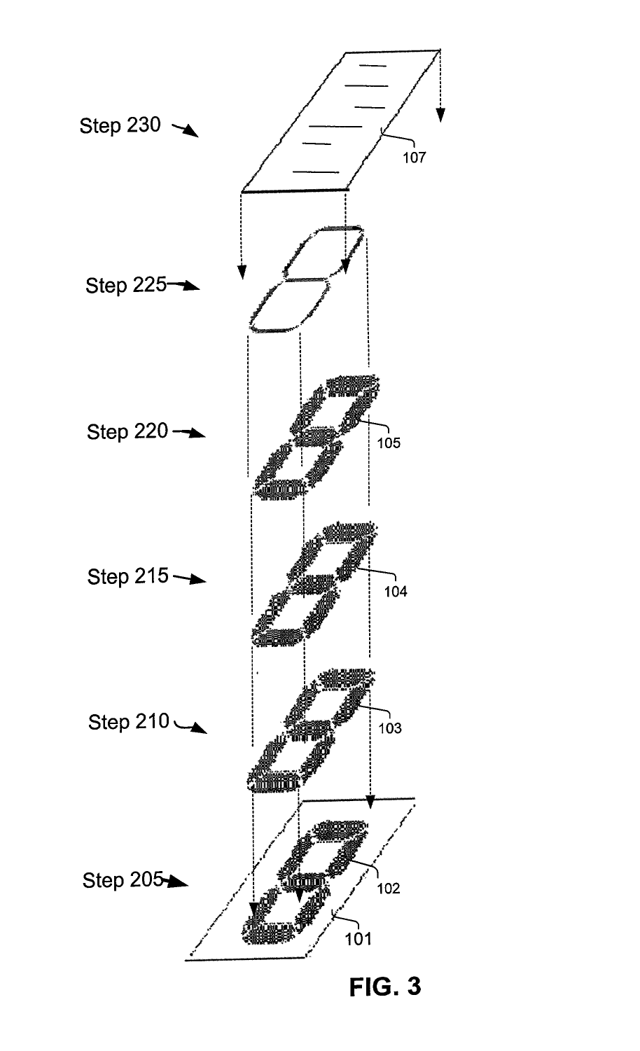

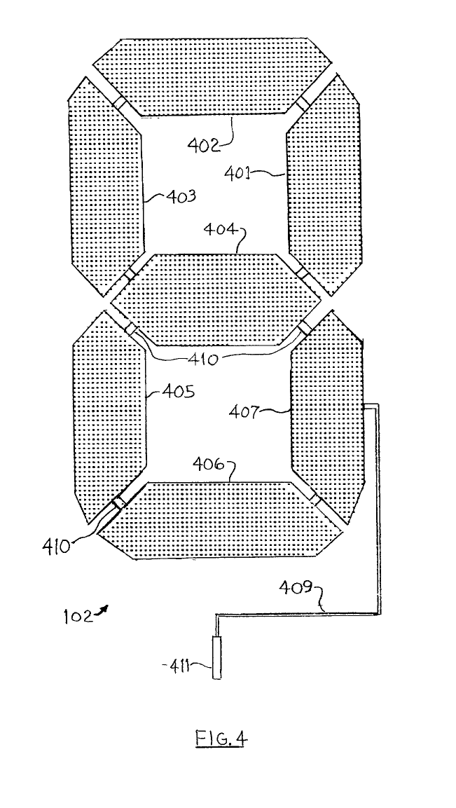

FIG. 2 is a flow chart showing an exemplary sequence of steps for fabricating the electroluminescent display device shown in FIG. 1. FIG. 3 is a diagram further illustrating the sequence of steps shown in FIG. 2. Fabrication of the present device 100 is best understood by viewing FIGS. 2 and 3 in conjunction with one another. If substrate 101 is a metal or other conductor, such as aluminum, then at step 201, an insulative coating is first applied over the substrate using a compound such as Nazdar's Plastic Plus (Nazdar Mid-America, St. Louis, Mo.). If substrate 101 is formed from a non-conductor, such as a polyester film, polycarbonate, or other plastic material, no coating is required.

At step 205, rear electrode 102 is applied over a front surface of substrate 101. In an exemplary embodiment, rear electrode 102 is formed of conductive particles, e.g., silver or carbon, dispersed in a polymeric or other binder to form a screen printable ink. In one embodiment, rear electrode 102 may comprise a silver particle ink such as DuPont 7145. Alternatively, rear electrode 102 may comprise a conductive polymer such as polyaniline, polypyrrole, and poly(3,4-ethylenedioxythiophene). In an exemplary embodiment, a carbon rear electrode 102 may have a thickness of between approximately 2×10⁻⁴ inches and 6×10⁻⁴ inches. It is to be noted that rear electrode layer 102, as well as each of the layers 103-107 that are successively applied in fabricating device 100, may be applied by any appropriate method, including an ink jet process, a stencil, flat coating, brushing, rolling, spraying, etc.

FIG. 4 is a schematic illustration of a rear electrode layer 102 of a seven-segment electroluminescent display device 100 in accordance with the embodiment of FIGS. 1-3. As shown in FIG. 4, rear electrode 102 includes segments 401-407, intercoupled by conductive interconnecting strips 410, and collectively coupled to a rear electrode lead 409. Alternatively, rear electrode layer 102 may cover the entire substrate 101, but this layer 102 typically covers only the illumination area (the area covered by phosphor layer 104). Interconnecting strips 410 are typically ⅛″ wide, but other widths may be employed, depending on the current drawn by device 100.

At step 210, dielectric layer 103 is applied over rear electrode layer 102. In an exemplary embodiment, dielectric layer 48 comprises a high dielectric constant material, such as barium titanate dispersed in a polymeric binder to form a screen printable ink. In one embodiment, the dielectric may be an ink such as DuPont 7153. Dielectric layer 103 may cover substrate 101 either entirely, or may alternatively cover only the illumination area. Alternatively, dielectric layer 103 may include a high dielectric constant material such as alumina oxide dispersed in a polymeric binder. The alumina oxide layer is applied over rear electrode 164 and cured by exposure to UV light. In an exemplary embodiment, dielectric layer 103 may have a thickness of between approximately 6×10⁻⁴ inches and 1.5×10⁻³ inches.

In an alternative embodiment, dielectric layer 102 includes two layers (not shown) of high dielectric constant material. In this embodiment, the first layer of dielectric layer 102 comprises barium titanate, and is applied over rear electrode layer 205 and is then UV cured to dry under a UV lamp. The second layer of dielectric layer 102 is applied over the layer of barium titanate and UV cured under a UV lamp to form dielectric layer 103. In accordance with one embodiment, dielectric layer 102 has substantially the same shape as the illumination area, but extends approximately 1/16″ to ⅛″ beyond the illumination area. Alternatively, dielectric layer 102 may cover substantially all of substrate 101.

At step 215, phosphor layer 104 is applied over dielectric layer 210. The size of the illumination area covered by phosphor layer 104 may range from approximately 1 sq. inch to 100 sq. inches. In an exemplary embodiment, phosphor layer 104 is formed of electroluminescent phosphor particles, e.g., zinc sulfide doped with copper or manganese which are dispersed in a polymeric binder to form a screen printable ink. In one embodiment, the phosphor layer comprises DuPont 7155 binder+55% Sylvania TNE 420 phosphor. Layer 104 may alternatively comprise light emitting polymers (LEPs) such as poly(p-phenylene vinylene) or poly[2-methoxy-5-(2′-ethylhexyloxy)-1,4-phenylenevinylene]. In a further alternative embodiment, layer 104 comprises OLEDs (organic light emitting devices or diodes) such as Tris(8-hydroxyquinolato) aluminum, Tetra(2-methyl-8-hydroxyquinolato) boron, and lithium salt. See “Progress with Light-Emitting Polymers”, by Mark T.Bernius, Mike Inbasekaran, Jim Obrien and Weishi Wu in Advanced Materials 2000, 12, No. 23, December 1. Light emitting polymers and OLEDs operate off low voltage and are more readily adaptable to being applied in thin layers than zinc sulfide phosphors, which exhibit graininess when applied as a thin coating. In an exemplary embodiment, phosphor layer 104 may have a thickness of between approximately 8×10⁻⁴ inches and 1.2×10⁻³ inches.

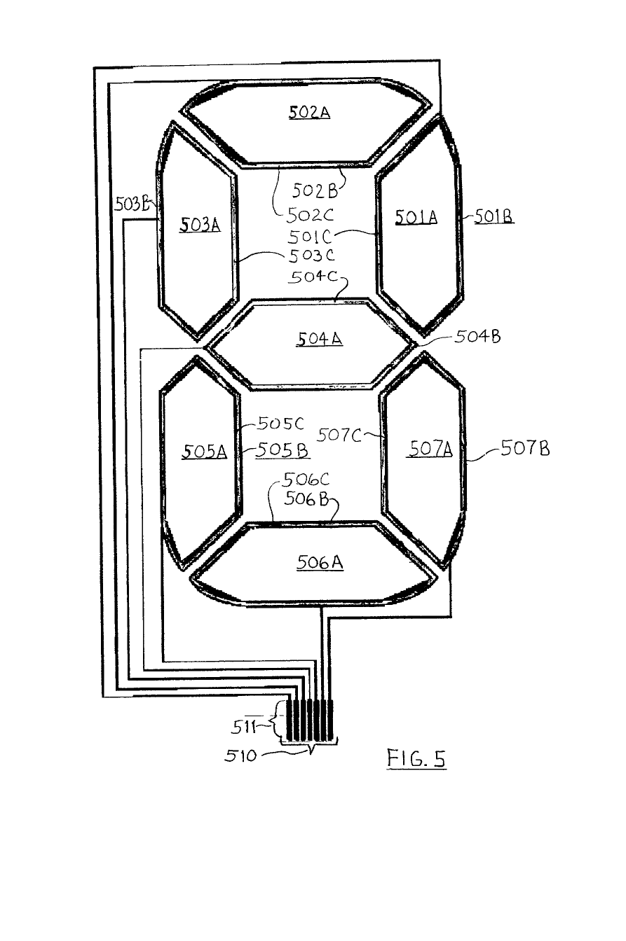

FIG. 5 is a schematic illustration of dielectric, phosphor, conductive, and front electrode layers of the EL display device 100 of FIGS. 1 and 2. As shown in FIG. 5, device 100 comprises seven main segments. Segments 501A-507A represent the rear electrode and phosphors layers 102/104, and segments 501B-507B represent the approximate relative sizes of the dielectric and conducting layers 103/105, which are slightly larger than the corresponding segments 501A-507A. The relative widths of the segments 50xA/50xB shown in FIG. 5 are approximate, and a device fabricated in accordance with the present method may function properly with relative widths other than those depicted.

At step 220, conductive layer 105 is printed over phosphor layer 104, extending about 1/16″ to b 1/8″ beyond phosphor area 104. The distance beyond the phosphor layer to which conductive layer 105 extends is a function of the size of the device. Accordingly, the extension of conductive layer 105 beyond phosphor area 104 may advantageously be between approximately 2 percent and 10 percent of the width of phosphor layer 104.

In an exemplary embodiment, conductive layer 105 comprises indium tin oxide (ITO) particles in the form of a screen printable ink such as DuPont 7160. In an alternative embodiment, conductive layer is non-metallic and is translucent or transparent, and comprises a conductive polymer, such as polyaniline, polypyrrole, poly(3,4-ethylenedioxythiophene), or poly-phenyleneamine-imine. In an exemplary embodiment, an ITO conductive layer 105 may have a thickness of between approximately 2×10⁻⁴ inches and 5×10⁻⁴ inches.

At step 225, a front electrode, or more specifically, a front outlining electrode layer 106, comprising a conductive material such as silver or carbon, is applied onto the outer perimeter of conductive layer 105 to transport energy thereto. Front electrode 106 is typically 1/16″ to ⅛″ wide strip, approximately 2 percent to 20 percent of the width of conductive layer 105, depending on the current drawn by device 100 and the length of the device from the controller or power source. For example, front electrode 106 may be approximately ⅛″ wide for a 50″ wire run from the controller. Front outlining electrode layer 106 is represented by shaded portions 501C-507C shown in FIG. 5.

Front electrode leads 510 may be screen printed onto substrate 101, or may be fabricated as interconnect tabs 511 extending beyond the substrate to facilitate connection to a power source or controller. In one embodiment, front outlining electrode layer 106 contacts substantially the entire outer perimeter of conductive layer 105 and does not overlap rear electrode 409. In an alternative embodiment, front electrode 106 contacts only about 25% of outer perimeter of conductive layer 105. Front electrode may be fabricated to contact any amount of the outer perimeter of conductive layer 105 from about 25% to about 100%. Front outlining electrode 106 may, for example, comprise silver particles that form a screen printable ink such as DuPont 7145. In an alternative embodiment, front outlining electrode 106 is non-metallic and is translucent or transparent, and comprises a conductive polymer, such as polyaniline, polypyrrole, poly(3,4-ethylenedioxythiophene), or poly-phenyleneamine-imine. Fabricating front and rear electrodes 106/102 with polymers such as the aforementioned compounds would make device 100 more flexible, as well as more durable and corrosion resistant. In an exemplary embodiment, a silver front outlining electrode layer 106 may have a thickness of between approximately 8×10⁻⁴ inches and 1.1×10⁻³ inches.

At step 230, a clear protective coating 107 is applied to the entire sheet of underlying layers including front outlining electrode layer 106 and conductive layer 220. The protective coating may be an insulative clear coating such as DuPont 5018A. The protective coating may also be a colored translucent coating.

### Reverse Build

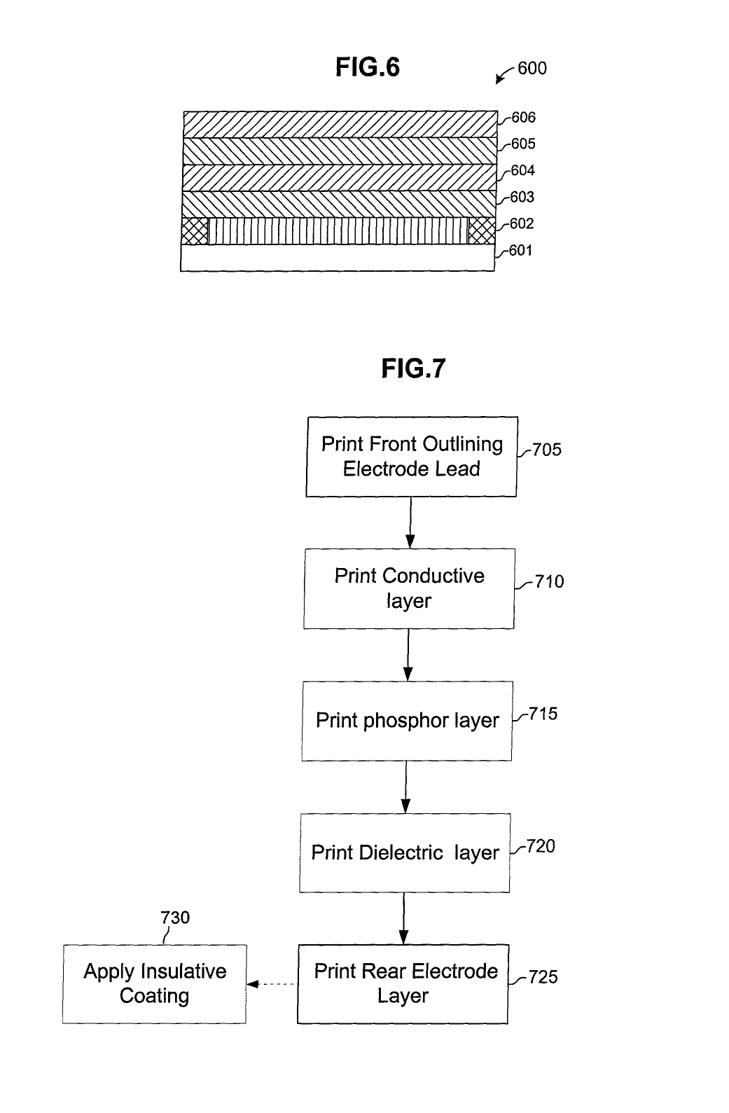

In an alternative embodiment, wherein a polycarbonate or other transparent substrate is used, the order of application of each of the layers applied to the substrate is reversed with respect to FIGS. 1-5 and the description thereof. FIG. 6 is a schematic illustration of an electroluminescent multi-segment display device 600 in accordance with an alternative embodiment of the present invention, and FIG. 7 is a flow chart showing an exemplary sequence of steps for fabricating the electroluminescent display device 600 shown in FIG. 6. Fabrication of the present device 600 is best understood by viewing FIGS. 6 and 7 in conjunction with one another.

Using a clear (transparent or translucent) or tinted translucent insulative material, such as polycarbonate film, as a ‘substrate’ 601, the layers described above with respect to device 100 may be applied as a ‘reverse build’ to fabricate electroluminescent multi-segment display device 600. In the present embodiment, light emitted by device 600 shines through the polycarbonate film 601.

As shown in FIGS. 6 and 7, at step 705, a front electrode, or more specifically, a front outlining electrode layer 602, comprising a conductive material such as silver ink, is applied onto substrate 601. Front outlining electrode layer 602 is shaped in accordance with front outlining electrode layer 106, described above, so that front electrode 106 is effectively a strip having a width of approximately 2 percent to 20 percent of the width of conductive layer 603, depending on the current drawn by device 100 and the length of the device from the controller or power source.

At step 710, conductive layer 603 is applied over front outlining electrode layer 602 and substrate 601. At step 715, phosphor layer 604 is applied over conductive layer 603. Layer 604 may alternatively comprise light emitting polymers (LEPs) such as poly(p-phenylene vinylene) or poly[2-methoxy-5-(2′-ethylhexyloxy)-1,4-phenylenevinylene]. Phosphor layer 604 is preferably smaller than conductive layer 603, as described above in step 220 with respect to the relative sizes of phosphor and conductive layers 104/105. At step 720, dielectric layer 605 is applied onto phosphor layer 604. At step 725, rear electrode 606 is applied over dielectric layer 605. Finally, at step 730, a clear protective coating 107 is optionally applied to the entire sheet of underlying layers.

In an alternative embodiment, phosphor layer 104/604 includes an insulating material in the phosphor binder, and therefore corresponding EL multi-segment display devices may be fabricated in accordance with the methods described above minus dielectric layer 103/605, thereby combining the phosphor and dielectric layers into a single layer 104/604. In addition, in the situation where a plurality of multiple segment devices 100 are to be employed in proximity to one another, such as on a scoreboard or price display sign, more than one of the devices may be advantageously fabricated onto a single substrate.

Front and rear electrode layers 602/606, as well as conductive layer 603, may alternatively comprise conductive polymers including polyaniline, polypyrrole, and poly(3,4-ethylenedioxythiophene).

### Multi-Segment Device Operation

In operation, a controller (not shown) including a power supply is connected to front electrode leads 510 and rear electrode lead 409 and a voltage is selectively applied across one or more corresponding rear electrode/front electrode segments 401-407/501-507 via the corresponding leads 411 and 510, respectively, to activate phosphor layer 104. For example, to display the letter “E”, current is applied to rear electrode segments 402-406 and front electrode segments 502-506. If dielectric layer 103/ cover substrate 101 either entirely, Current is transmitted between rear electrode 164 and front electrode 106 through dielectric, phosphor and ITO layers 103-105 to illuminate the specific segments to which the current is applied. Optional interconnect tabs 411 and 511 facilitate attachment of a connector to rear electrode lead 409 and front electrode leads 510, respectively.

In accordance with the present invention, an electroluminescent display panel is fabricated to include one or more multi-segment display devices integrated therewith. For example, an EL panel may be readily constructed from an array of the present multisegment display devices suitably juxtaposed to display a message consisting of multiple alphabetic or numeric (‘alphanumeric’) characters. In such a configuration, a controller selectively applies power to each individual EL display device within the array, and a programmable microprocessor within controller provides the intelligence to determine which individual device and segments within the device are to be driven to display the intended message. The desired alphanumeric characters are displayed via the microprocessor to change the sequence of display for various applications, including pricing charts, scoreboards, billboards, road signs such as speed limit signs and directional road signs that can be re-programmed according to traffic parameters, and city bus information bars.

The above described embodiments are exemplary and are not meant to limit the scope of the appended claims. The multiple segment electroluminescent display device disclosed herein may include more than seven segments and may also be fabricated in accordance with other methods and materials in addition to those specifically set forth above.

What is claimed is:

1. A multiple-segment electroluminescent display device comprising a substrate with a plurality of segments formed thereon, each of the segments comprising:
a first electrode formed on the substrate;
a dielectric layer substantially aligned with the first electrode and fabricated onto the first electrode;
a phosphor layer substantially aligned with the dielectric layer and fabricated thereon;
a conductive layer substantially aligned with the phosphor layer and fabricated onto the phosphor layer; and
a second electrode fabricated onto an outer perimeter of the conductive layer;
wherein one of the segments is activated in response to a current being applied to the first electrode and the second electrode of said one of the segments to cause the illumination thereof.

2. The display device of claim 1, wherein the device includes 6 said segments arranged end-to-end to form a enclosed area containing a seventh one of the segments.

3. The display device of claim 2, wherein a selected plurality of the segments are simultaneously activated to display an alphanumeric character.

4. A sign comprising a plurality of display devices in accordance with claim 3, wherein the devices are arranged to display a multiple digit number.

5. A sign comprising a plurality of display devices in accordance with claim 3, wherein the devices are arranged to display a multiple alphanumeric characters.

6. The display device of claim 1, wherein the first electrode, the second electrode, and each said layer is applied by a screen printing process.

7. The display device of claim 1, wherein the conductive layer comprises indium tin oxide.

8. The display device of claim 1, wherein a translucent coating is applied over the second electrode.

9. The display device of claim 1, wherein the dielectric layer and the phosphor layer are larger in surface area than the phosphor layer.

10. The display device of claim 1, wherein the second electrode comprises a strip contacting the outer perimeter of the conductive layer.

11. The display device of claim 1, wherein the device includes more than 7 said segments.

12. The display device of claim 1, wherein the device includes 6 of the segments arranged in a substantially rectangular pattern enclosing a seventh one of the segments.

13. A multiple-segment electroluminescent display device comprising a translucent substrate with a plurality of segments formed thereon, each of the segments comprising:
a first electrode formed on the substrate;
a conductive layer fabricated onto the first electrode and the substrate;
a phosphor layer substantially aligned with the conductive layer and fabricated thereon;
a dielectric layer substantially aligned with the phosphor layer and fabricated thereon; and
a second electrode substantially aligned with the dielectric layer and fabricated thereon;
wherein the first electrode contacts only the outer perimeter of the conductive layer; and
wherein one of the segments is activated in response to a current being applied to the first electrode and the second electrode of said one of the segments to cause the illumination thereof.

14. The display device of claim 13, wherein the first electrode is comprises a strip contacting the outer perimeter of the conductive layer.

15. The display device of claim 13, wherein the device includes 6 said segments arranged end-to-end to form a enclosed area containing a seventh one of the segments.

16. The display device of claim 15, wherein a selected plurality of the segments are simultaneously activated to display an alphanumeric character.

17. A sign comprising a plurality of display devices in accordance with claim 16, wherein the devices are arranged to display a multiple alphanumeric characters.

18. The display device of claim 13, wherein the first electrode, the second electrode, and each said layer is applied by a screen printing process.

19. The display device of claim 13, wherein the device includes more than 7 said segments.

20. A method for fabricating a multiple-segment electroluminescent display device comprising a plurality of segments formed on a substrate, the method comprising the steps of:
applying a first electrode to a surface of the substrate;
applying, onto the first electrode; a dielectric layer substantially aligned therewith;
applying, onto the dielectric layer, a phosphor layer substantially aligned therewith;
applying, onto the phosphor layer, a conductive layer substantially aligned therewith; and
applying a second electrode onto an outer perimeter of the conductive layer;
wherein one of the segments is activated in response to a current being applied to the first electrode and the second electrode of said one of the segments to cause the illumination thereof.

21. The method of claim 20, wherein the first electrode, the second electrode, and each said layer is applied by a screen printing process.

22. The method of claim 20, wherein the first electrode is comprises a strip contacting the outer perimeter of the conductive layer.

23. The method of claim 20, wherein the device includes 6 said segments arranged end-to-end to form a enclosed area containing a seventh one of the segments.

24. The method of claim 20, wherein a selected plurality of the segments are simultaneously activated to display an alphanumeric character.

25. The method of claim 20, wherein the device includes more than 7 said segments.

26. A method for fabricating a multiple-segment electroluminescent display device comprising a plurality of segments formed on a substrate, the method comprising the steps of:
applying a first electrode to a surface of the substrate;
applying a conductive layer onto the first electrode and the substrate;
applying, onto the conductive layer, a phosphor layer substantially aligned therewith;
applying, onto the phosphor layer, a dielectric layer substantially aligned therewith; and
applying, onto the dielectric layer, a second electrode substantially aligned therewith;
wherein the first electrode comprises a strip contacting the outer perimeter of the conductive layer; and
wherein one of the segments is activated in response to a current being applied to the first electrode and the second electrode of said one of the segments to cause the illumination thereof.

27. The method of claim 26, wherein the first electrode is comprises a strip contacting the outer perimeter of the conductive layer.

28. The method of claim 26, wherein the device includes 6 said segments arranged end-to-end to form a enclosed area containing a seventh one of the segments.

29. The method of claim 26, wherein a selected plurality of the segments are simultaneously activated to display an alphanumeric character.

30. The method of claim 26, wherein the device includes more than 7 said segments.
